(19) United States
(12) Patent Application Publication
(10) Pub. No.: US 2023/0249549 A1
(43) Pub. Date: Aug. 10, 2023

(54) VEHICLE CONTROL DEVICE, STORAGE MEDIUM FOR STORING COMPUTER PROGRAM FOR VEHICLE CONTROL, AND METHOD FOR CONTROLLING VEHICLE

(71) Applicant: TOYOTA JIDOSHA KABUSHIKI KAISHA, Toyota-shi (JP)

(72) Inventor: Kenta KUMAZAKI, Tokyo-to (JP)

(73) Assignee: TOYOTA JIDOSHA KABUSHIKI KAISHA, Toyota-shi (JP)

(21) Appl. No.: 18/084,874

(22) Filed: Dec. 20, 2022

(30) Foreign Application Priority Data
Feb. 7, 2022 (JP) 2022-017382

(51) Int. Cl. B60K 31/00

(52) U.S. Cl. CPC B60K 31/0066

(57) ABSTRACT

A vehicle control device has a processor configured to set a reference curve speed when a vehicle is traveling on a curved road based on the speed of the vehicle and the curvature radius of the road, determine a target curve speed based on the reference curve speed and a current correction value, count the number of changes the speed of the vehicle has been changed from the target curve speed by driver operation and calculate a new correction value for the reference curve speed based on a correction coefficient determined each time the number of changes has been counted and the amount of change in the speed of the vehicle that has changed from the target curve speed by driver operation, wherein the subsequent target curve speed is determined based on the reference curve speed and the new correction value.

### FIELD

The present disclosure relates to a vehicle control device, a storage medium storing a computer program for vehicle control, and a method for controlling a vehicle.

### BACKGROUND

An autonomous control system mounted in a vehicle generates a navigation route for the vehicle based on the current location of the vehicle, the destination location of the vehicle, and a navigation map. The autonomous control system estimates the current location of the vehicle using the map information and controls the vehicle to travel along the navigation route.

The autonomous control system also controls the speed of the vehicle so that the vehicle travels at a driver-set speed which has been set by the driver. The driver-set speed is set by the driver based on the speed limit (legal speed limit) for the road on which the vehicle is traveling, for example. When the vehicle travels on a curved road, acceleration acts on the driver in the lateral direction.

Since the driver may feel discomfort if the lateral acceleration is strong while the vehicle is traveling, the autonomous control system sets a curve reference speed in response to the curvature radius of the road. The autonomous control system functions to prevent excessive lateral acceleration from being produced by traveling on the curved road at the curve reference speed. When the driver-set speed is faster than the curve reference speed, the autonomous control system decelerates the speed of the vehicle to the curve reference speed as the vehicle travels on the curved road.

For example, Japanese Unexamined Patent Publication No. 2020-192824 proposes a driving behavior control system that sets parameters establishing the driving behavior for an autonomous driven vehicle in response to a specific driving situation, detects passenger feedback for the driving behavior resulting from the parameters and, based on the parameters that have been changed in response to the feedback, establishes driving behavior for cases in which the autonomous driven vehicle subsequently encounters the specific driving situation or a driving situation similar to the specific driving situation.

### SUMMARY

Since the response to lateral acceleration when a vehicle travels will differ depending on the driver, the allowable range for lateral acceleration will also differ depending on the driver. Some drivers may feel that the curve reference speed set by the autonomous control system is slow (a wide allowable range for lateral acceleration), while other drivers may feel that the curve reference speed is fast (a narrow allowable range for lateral acceleration).

There is potentially room for improvement in terms of controlling vehicle speed when a vehicle is traveling on a curved road, so that all drivers are satisfied.

It is an object of the present disclosure to provide a vehicle control device that can cause a vehicle to travel on a curved road at a lateral acceleration that is satisfactory for different drivers.

One embodiment of the invention provides a vehicle control device. The vehicle control device has a reference curve speed setting unit that sets a reference curve speed as a speed reference when a vehicle is traveling on a curved road, based on the speed of the vehicle and the curvature radius of the road on which the vehicle is traveling, a target curve speed determining unit that determines a target curve speed as a target speed at which the vehicle is to be controlled based on the reference curve speed and a current correction value corresponding to the curvature radius of the road when the vehicle is traveling on the curved road, a counting unit that counts the number of changes as the number of times the speed of the vehicle has been changed from the target curve speed by driver operation when the vehicle is traveling on the curved road, and a correction value calculating unit that calculates a new correction value for the reference curve speed corresponding to the curvature radius of the road based on a correction coefficient determined based on the number of changes, and the amount of change in the speed of the vehicle that has changed from the target curve speed by the driver operation each time the number of changes has been counted, in which the target curve speed determining unit determines the subsequent target curve speed based on the reference curve speed and the new correction value corresponding to the curvature radius of the road.

In this vehicle control device, the correction value calculating unit preferably calculates the new correction value as the sum of the products of the correction coefficients and the amount of change in the speed of the vehicle for each time the speed of the vehicle has been changed from the target curve speed by the driver operation.

In this vehicle control device, the relationship between the correction coefficient and number of changes preferably has a first zone in which the correction coefficient increases as the number of changes increases, a second zone in which the correction coefficient increases more than the first zone as the number of changes increases, and a third zone in which the correction coefficient increases less than the second zone as the number of changes increases.

In this vehicle control device, the correction value calculating unit preferably corrects the current correction value for the curvature radius of the road before and after the curvature radius of the road for which the new correction value was calculated so that difference between the new correction value and the current correction value for the curvature radius of the road before and after is at or below a predetermined reference value when the new correction value has been determined.

In this vehicle control device, it is preferable that the correction value calculating unit calculates the new correction value for the reference curve speed corresponding to the curvature radius of the road for each type of road, and the correction value calculating unit calculates the new correction value for the reference curve speed corresponding to the curvature radius of another road, based on the new correction value when the new correction value has been determined for one road on which the vehicle is traveling.

According to another embodiment, a non-transitory storage medium storing a computer program for vehicle control is provided. The computer program for vehicle control causes a processor execute a process, the process includes setting a reference curve speed as a speed reference when a vehicle is traveling on a curved road, based on a speed of the vehicle and the curvature radius of the road on which the vehicle is traveling, determining a target curve speed as a target speed at which the vehicle is to be controlled based on the reference curve speed and a current correction value corresponding to the curvature radius of the road when the vehicle is traveling on the curved road, counting number of changes as the number of times the speed of the vehicle has been changed from the target curve speed by driver operation when the vehicle is traveling on the curved road, and calculating a new correction value for the reference curve speed corresponding to the curvature radius of the road based on a correction coefficient determined based on the number of changes, and the amount of change in the speed of the vehicle that has changed from the target curve speed by the driver operation each time the number of changes has been counted, in which the subsequent target curve speed is determined based on the reference curve speed and the new correction value corresponding to the curvature radius of the road.

Yet another embodiment of the invention provides a method for controlling a vehicle carried out by a vehicle control device. The method for controlling a vehicle includes setting a reference curve speed as a speed reference when a vehicle is traveling on a curved road, based on the speed of the vehicle and the curvature radius of the road on which the vehicle is traveling, determining a target curve speed as a target speed at which the vehicle is to be controlled based on the reference curve speed and a current correction value corresponding to the curvature radius of the road when the vehicle is traveling on the curved road, counting number of changes as the number of times the speed of the vehicle has been changed from the target curve speed by driver operation when the vehicle is traveling on the curved road, and calculating a new correction value for the reference curve speed corresponding to the curvature radius of the road based on a correction coefficient determined based on the number of changes, and the amount of change in the speed of the vehicle that has changed from the target curve speed by the driver operation each time the number of changes has been counted, in which the subsequent target curve speed is determined based on the reference curve speed and the new correction value corresponding to the curvature radius of the road.

The vehicle control device of the present disclosure can cause a vehicle to travel on a curved road at a lateral acceleration that is satisfactory for different drivers.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating operation of the drive planning device of the embodiment in overview, showing the state of a vehicle traveling on a road that includes a curve.

FIG. 1B is a diagram illustrating operation of the drive planning device of the embodiment in overview, showing an example of the relationship between curvature radius and reference curve speed.

FIG. 1C is a diagram illustrating operation of the drive planning device of the embodiment in overview, and a reference curve speed.

FIG. 1D is a diagram illustrating operation of the drive planning device of the embodiment in overview, and lateral acceleration.

FIG. 2A is a diagram illustrating operation of the drive planning device of the embodiment in overview, and correction value calculation processing when the vehicle has accelerated.

FIG. 2B is a diagram illustrating operation of the drive planning device of the embodiment in overview, and a new target curve speed.

FIG. 3 is a general schematic drawing of a vehicle in which a vehicle control system of the embodiment is mounted.

FIG. 4 is an example of an operation flow chart for target curve speed determination processing by a drive planning device of the embodiment.

FIG. 5 is a diagram showing an example of the relationship between correction value and reference curvature radius.

FIG. 6 is a diagram illustrating target curve speed determination processing.

FIG. 7 is an example of an operation flow chart for correction value calculation processing by a drive planning device of the embodiment.

FIG. 8 is a diagram showing an example of the relationship between the correction coefficient and number of changes.

FIG. 9A is a diagram illustrating correction value calculation processing when a vehicle has decelerated.

FIG. 9B is a diagram illustrating a new target curve speed.

FIG. 10 is a diagram illustrating the relationship between correction value and reference curvature radius, for Modification Example 1.

### DESCRIPTION OF EMBODIMENTS

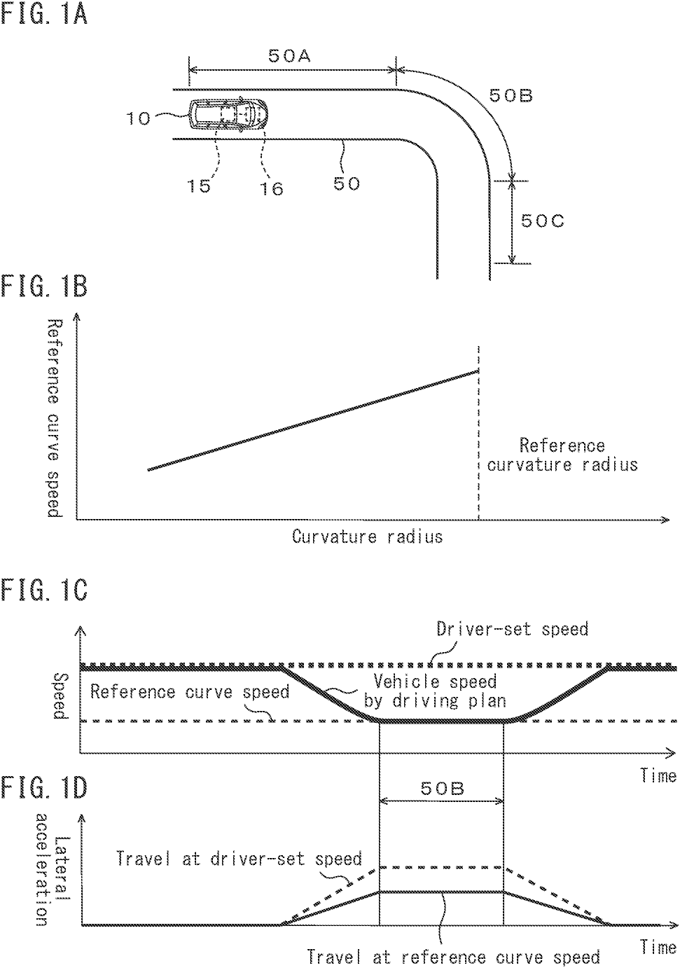

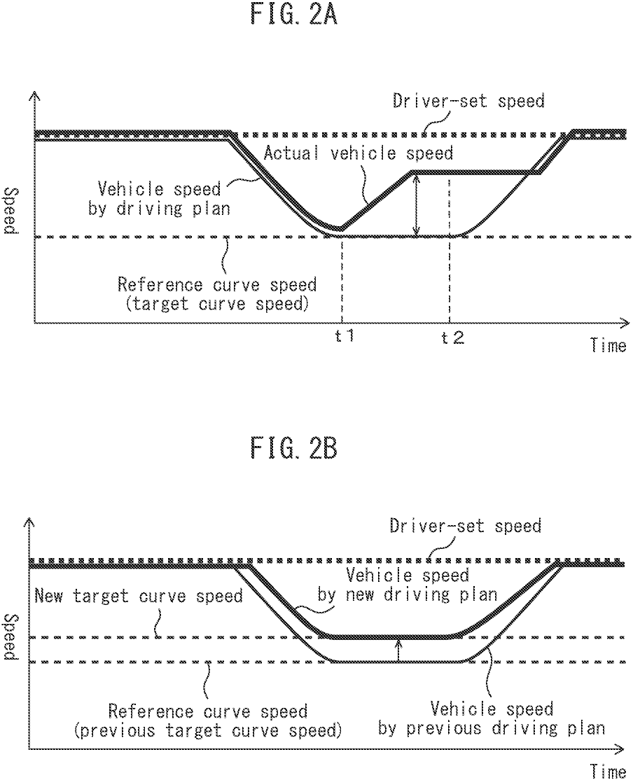

FIG. 1A to FIG. 1D, FIG. 2A and FIG. 2B are diagrams showing operation of a drive planning device 15 according to an embodiment in overview. FIG. 1A is a diagram showing the state of a vehicle 10 traveling on a road 50 that includes a curve. FIG. 1B is a diagram showing an example of the relationship between curvature radius and reference curve speed. FIG. 1C is a diagram illustrating reference curve speed. FIG. 1D is a diagram illustrating lateral acceleration. FIG. 2A is a diagram illustrating correction value calculation processing when the vehicle 10 has accelerated. FIG. 2B is a diagram showing a new target curve speed.

Operation for vehicle control processing by the drive planning device 15 as disclosed herein will now be described in overview with reference to FIG. 1A to FIG. 1D, FIG. 2A and FIG. 2B.

As shown in FIG. 1A, the vehicle 10 is traveling on the road 50. The road 50 has a straight road zone 50A, a curved road zone 50B and a straight road zone 50C in that order in the traveling direction of the vehicle 10. The vehicle 10 is currently traveling in zone 50A.

The vehicle 10 has a drive planning device 15 and a vehicle control device 16. The drive planning device 15 generates a driving plan representing a scheduled traveling trajectory for the vehicle 10 until a predetermined time ahead. The driving plan is represented as a combination of the target location of the vehicle 10 and the target vehicle speed at the target location, at each time from the current time until the predetermined time. The vehicle 10 may be an autonomous vehicle.

The vehicle control device 16 controls each unit of the vehicle 10 based on a driving plan created by the drive planning device 15, to drive the vehicle. The drive planning device 15 also sets a reference curve speed as a speed reference for when the vehicle 10 travels on a curved road, based on map information, the speed of the vehicle and the curvature radius of the road 50 on which the vehicle 10 is traveling.

The reference curve speed is a speed representing the upper limit for the vehicle 10 traveling on a road having a curvature radius that is equal to or less than the reference curvature radius. The reference curvature radius is determined based on the speed of the vehicle 10. As shown in FIG. 1B, the reference curve speed is lower with a lower curvature radius. When the curvature radius of the road is greater than the reference curvature radius, the drive planning device 15 does not set the reference curve speed. The speed of the vehicle 10 is determined based on the driver-set speed.

If the vehicle 10 travels on a curved road at a speed equal to or less than the reference curve speed, then lateral acceleration acting on the driver will be limited to no greater than a predetermined reference acceleration. The lateral acceleration is an acceleration acting in the direction perpendicular to the traveling direction of the vehicle 10, as “centrifugal force”. This can minimize unpleasantness for the driver when the vehicle 10 travels on a curved road. Reducing the lateral acceleration to be at or below a predetermined reference acceleration also allows the vehicle 10 to stably travel on the scheduled traveling trajectory that has been planned.

In zone 50A which is a straight line, the drive planning device 15 generates a driving plan for the vehicle 10 so that it travels at a driver-set speed, representing the speed of the vehicle 10 that has been set by the driver.

Since the curvature radius of zone 50B which is a curved road is equal to or less than the reference curvature radius, the drive planning device 15 sets the reference curve speed for zone 50B. In zone 50B, the drive planning device 15 generates a driving plan for the vehicle 10 so that it travels at the reference curve speed.

FIG. 1C shows an example of the relationship between speed of the vehicle 10 and time, based on a driving plan. In zone 50A, the vehicle 10 travels at the driver-set speed, while in zone 50B the vehicle 10 travels at the reference curve speed and in zone 50C the vehicle 10 travels at the driver-set speed.

Since the reference curve speed is slower than the driver-set speed, the vehicle 10 decelerates to the reference curve speed just before zone 50B which is a curved road, and after having passed through zone 50B it accelerates to the driver-set speed in zone 50C.

As shown in FIG. 1D, lateral acceleration on the driver can be reduced if the vehicle 10 travels in zone 50B at the reference curve speed, compared to if the vehicle 10 has traveled in zone 50B at the driver-set speed.

As shown in FIG. 2A, when the vehicle 10 travels in zone 50B, a driver who feels that the speed of the vehicle 10 is slow may activate acceleration to increase the speed of the vehicle 10 above the reference curve speed.

This causes the actual speed of the vehicle 10 between time t1 and time t2, in zone 50B, to increase above the speed of the driving plan. In part of zone 50C as well, the actual speed of the vehicle 10 increases above the speed of the vehicle 10 according to the driving plan.

The drive planning device 15 counts the number of times that the speed of the vehicle 10 has changed from the speed of the driving plan by driver operation, while the vehicle 10 is traveling on the curved road. The drive planning device 15 may also count the number of times that the speed of the vehicle 10 has changed from the speed of the driving plan by driver operation while the vehicle 10 is traveling on a curved road, for each different curvature radius of the road.

Each time the number of changes has been counted, the drive planning device 15 calculates a correction value for the reference curve speed corresponding to the curvature radius of the road, based on a correction coefficient determined based on the number of changes, and the amount of change in the speed of the vehicle 10 that has changed from the speed of the driving plan by driver operation.

As shown in FIG. 2A, when the vehicle 10 again travels on a road having the same curvature radius as zone 50B, the drive planning device 15 determines the target curve speed to be a target speed at which the vehicle 10 is to be controlled when the vehicle 10 is traveling on the curved road, based on the reference curve speed and the current correction value corresponding to the curvature radius of the road.

As shown in FIG. 2B, the new target curve speed is corrected so as to reflect the previous accelerating operation by the driver and to be increased above the previous reference curve speed.

When the vehicle 10 has again traveled on a road with the same curvature radius as zone 50B, the drive planning device 15 determines a new correction value for the target curve speed corresponding to the curvature radius of the road, when a driver who feels that the speed of the vehicle 10 is slow has performed an accelerating operation so that the speed of the vehicle 10 has been increased above the speed of the driving plan.

As shown in FIG. 2B, when the vehicle 10 once again travels on a road having the same curvature radius as zone 50B, the drive planning device 15 again determines a new target curve speed based on the reference curve speed and the current correction value corresponding to the curvature radius of the road. The new target curve speed is corrected so as to reflect the previous accelerating operation by the driver and to be even further increased above the previous target curve speed.

As explained above, each time the number of changes has been counted, the drive planning device 15 determines the target curve speed using a correction value calculated based on the correction coefficient determined based on the number of changes, and the amount of change in the speed of the vehicle 10 that has changed from the target curve speed by driver operation. This allows the drive planning device 15 to cause the vehicle to travel on the curved road at a lateral acceleration that is satisfactory for different drivers.

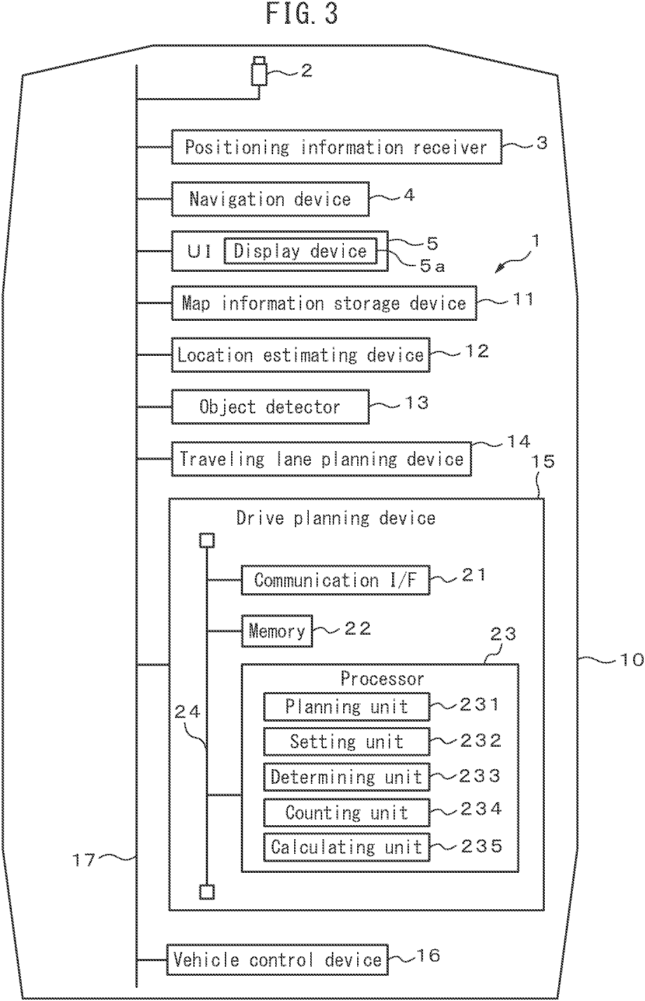

FIG. 3 is a general schematic drawing of a vehicle 10 in which a vehicle control system 1 of the embodiment is mounted. The vehicle 10 has a camera 2, a positioning information receiver 3, a navigation device 4, a user interface (UI) 5, a map information storage device 11, a location estimating device 12, an object detector 13, a traveling lane planning device 14, a drive planning device 15 and a vehicle control device 16. The vehicle 10 may also have a LiDAR sensor, as a distance sensor (not shown) for measurement of the distance of the vehicle 10 to surrounding objects. The vehicle control system 1 has at least vehicle control device 16.

The camera 2, positioning information receiver 3, navigation device 4, UI 5, map information storage device 11, location estimating device 12, object detector 13, traveling lane planning device 14, drive planning device 15 and vehicle control device 16 are connected in a communicable manner through an in-vehicle network 17 that conforms to controller area network standards.

The camera 2 is an example of an imaging unit provided in the vehicle 10. The camera 2 is mounted inside the vehicle 10 and directed toward the front of the vehicle 10. The camera 2, for example, takes a camera image in which the environment of a predetermined region ahead of the vehicle 10 is shown, at a predetermined cycle. The camera image can show the road in the predetermined region ahead of the vehicle 10, and road features such as surface lane marking lines on the road. The camera 2 has a 2D detector composed of an array of photoelectric conversion elements with visible light sensitivity, such as a CCD or C-MOS, and an imaging optical system that forms an image of the photographed region on the 2D detector.

Each time a camera image is taken, the camera 2 outputs the camera image and the camera image photograph time at which the camera image was taken, through the in-vehicle network 17 to the location estimating device 12 and object detector 13, etc. The camera image is also used for processing at the location estimating device 12 to estimate the location of the vehicle 10. At the object detector 13, the camera image is used for processing to detect other objects surrounding the vehicle 10.

The positioning information receiver 3 outputs positioning information that represents the current location of the vehicle 10. The positioning information receiver 3 may be a GNSS receiver, for example. The positioning information receiver 3 outputs positioning information and the positioning information acquisition time at which the positioning information has been acquired, to the navigation device 4 and map information storage device 11, etc., each time positioning information is acquired at a predetermined receiving cycle.

Based on the navigation map information, the destination location of the vehicle 10 input through the UI 5, and positioning information representing the current location of the vehicle 10 input from the positioning information receiver 3, the navigation device 4 generates a navigation route from the current location to the destination location of the vehicle 10. The navigation route includes information relating to the locations of right turns, left turns, merging and branching. When the destination location has been newly set or the current location of the vehicle 10 has exited the navigation route, the navigation device 4 generates a new navigation route for the vehicle 10. Every time a navigation route is created, the navigation device 4 outputs the navigation route to the location estimating device 12 and the traveling lane planning device 14, etc., via the in-vehicle network 17.

The UI 5 is an example of the notification unit. The UI 5, controlled by the navigation device 4, drive planning device 15 and vehicle control device 16, notifies the driver of the vehicle 10 traveling information. The traveling information of the vehicle 10 includes information relating to the current location of the vehicle, the speed limit for the road and the current and future route of the vehicle, such as the navigation route. The UI 5 has a display device 5a such as a liquid crystal display or touch panel, for display of the traveling information. The UI 5 may also have an acoustic output device (not shown) to notify the driver of traveling information. The UI 5 also generates an operation signal in response to operation of the vehicle 10 by the driver. The operation information may be, for example, a destination location, transit points, vehicle speed (driver-set speed) or other vehicle control information. The UI 5 also has a touch panel or operating button, for example, as an input device for inputting operation information from the driver to the vehicle 10. The driver sets the speed of the vehicle based on the speed limit for the road on which the vehicle 10 is traveling, for example. The UI 5 outputs the input operation information to the navigation device 4, the drive planning device 15 and the vehicle control device 16, etc., via the in-vehicle network 17.

The map information storage device 11 stores wide-area map information for a relatively wide area (an area of 10 to 30 km², for example) that includes the current location of the vehicle 10. The map information preferably has high precision map information including three-dimensional information for the road surface, the speed limit for the road, the curvature radius of the road, and information for the types and locations of structures and road features such as road lane marking lines.

The map information storage device 11 receives the wide-area map information from an external server via a base station, by wireless communication through a wireless communication device (not shown) mounted in the vehicle 10, in relation to the current location of the vehicle 10, and stores it in the storage device. Each time positioning information is input from the positioning information receiver 3, the map information storage device 11 refers to the stored wide-area map information and outputs map information for a relatively narrow area including the current location represented by the positioning information (for example, an area of 100 m² to 10 km²), through the in-vehicle network 17 to the location estimating device 12, object detector 13, traveling lane planning device 14, drive planning device 15 and vehicle control device 16, etc.

The location estimating device 12 estimates the location of the vehicle 10 at the camera image photograph time, based on the road features surrounding the vehicle 10 represented in the camera image. For example, the location estimating device 12 compares lane marking lines identified in the camera image with lane marking lines represented in the map information input from the map information storage device 11, and determines the estimated location and estimated declination of the vehicle 10 at the camera image photograph time. The location estimating device 12 estimates the road traveling lane where the vehicle 10 is located, based on the lane marking lines represented in the map information and on the estimated location and estimated declination of the vehicle 10. Each time the estimated location, estimated declination and traveling lane of the vehicle 10 are determined at the camera image photograph time, the location estimating device 12 outputs this information to the object detector 13, traveling lane planning device 14, drive planning device 15 and vehicle control device 16, etc.

The object detector 13 detects other objects around the vehicle 10 and their types (for example, vehicles) based on the camera image, for example. Other objects also include other vehicles traveling around the vehicle 10. The object detector 13 tracks other detected objects and determines the trajectories of the other objects. In addition, the object detector 13 identifies the traveling lanes in which the other objects are traveling, based on the lane marking lines represented in the map information and the locations of the objects. The object detector 13 outputs object detection information which includes information representing the types of other objects that were detected, information indicating their locations, and also information indicating their traveling lanes, to the traveling lane planning device 14 and drive planning device 15, etc.

At a traveling lane-planning creation time set in a predetermined cycle, the traveling lane planning device 14 selects a traffic lane on the road on which the vehicle 10 is traveling, within the nearest driving zone (for example, 10 km) selected from the navigation route, based on the map information, the navigation route and surrounding environment information and the current location of the vehicle 10, and generates a traveling lane plan representing the scheduled traveling lane for traveling of the vehicle 10. For example, the traveling lane planning device 14 generates a traveling lane plan for the vehicle 10 to travel on a traffic lane other than a passing traffic lane. Each time a traveling lane plan is created, the traveling lane planning device 14 outputs the drive planning device 15 of the traveling lane plan.

The drive planning device 15 carries out plan processing, setting processing, assessment processing, count processing and calculation processing. The traveling lane planning device 14 comprises a communication interface (IF) 21, a memory 22 and a processor 23 for this purpose. The communication interface 21, memory 22 and processor 23 are connected via signal wires 24. The communication interface 21 has an interface circuit to connect the traveling lane planning device 14 with the in-vehicle network 17. The drive planning device 15 is an example of the vehicle control device.

The memory 22 is an example of a memory unit, and it has a volatile semiconductor memory and a non-volatile semiconductor memory, for example. The memory 22 stores an application computer program and various data to be used for information processing carried out by the processor 23.

All or some of the functions of the drive planning device 15 are functional modules driven by a computer program operating on the processor 23, for example. The processor 23 has a planning unit 231, a setting unit 232, a determining unit 233, a counting unit 234 and a calculating unit 235. Alternatively, the functional module of the processor 23 may be a specialized computing circuit in the processor 23. The processor 23 comprises one or more CPUs (Central Processing Units) and their peripheral circuits. The processor 23 may also have other computing circuits such as a logical operation unit, numerical calculation unit or graphic processing unit.

At a driving plan creation time set with a predetermined cycle, the planning unit 231 carries out driving plan processing in which it generates a driving plan representing the scheduled traveling trajectory of the vehicle 10 up until a predetermined time (for example, 5 seconds), based on the traveling lane plan, the map information, the current location of the vehicle 10, the surrounding environment information and the vehicle status information. The surrounding environment information includes the locations and speeds of other vehicles traveling around the vehicle 10. The vehicle status information includes the current location of the vehicle 10, and the vehicle speed, acceleration and traveling direction. The driving plan is represented as a combination of the target location of the vehicle 10 and the target vehicle speed at the target location, at each time from the current time until the predetermined time. The cycle in which the driving plan is created is preferably shorter than the cycle in which the traveling lane plan is created. The drive planning device 15 generates a driving plan to maintain a spacing of at least a predetermined distance between the vehicle 10 and other objects (such as vehicles). The drive planning device 15 outputs the driving plan to the vehicle control device 16 for each driving plan generated. Other operation by the drive planning device 15 will be described in detail below.

The vehicle control device 16 controls each unit of the vehicle 10 based on the current location of the vehicle 10 and the vehicle speed and yaw rate, as well as on the driving plan generated by the drive planning device 15. For example, the vehicle control device 16 determines the steering angle, acceleration and angular acceleration of the vehicle 10 according to the driving plan and the speed and yaw rate of the vehicle 10, and sets the amount of steering, and the accelerator or brake level so as to match that steering angle, accelerator level and angular acceleration. The vehicle control device 16 also outputs a control signal corresponding to a set steering amount, to an actuator (not shown) that controls the steering wheel for the vehicle 10, via the in-vehicle network 17. The vehicle control device 16 also outputs a control signal corresponding to the set accelerator level, to a drive unit (engine or motor) of the engine of the vehicle 10, via the in-vehicle network 17. Alternatively, the vehicle control device 16 may output a control signal corresponding to a set brake level to the brake (not shown) of the vehicle 10, via the in-vehicle network 17.

The map information storage device 11, location estimating device 12, object detector 13, traveling lane planning device 14, drive planning device 15 and vehicle control device 16 are electronic control units (ECU), for example. As for FIG. 3, the map information storage device 11, location estimating device 12, object detector 13, traveling lane planning device 14, drive planning device 15 and vehicle control device 16 were explained as separate devices, but all or some of them may be constructed in a single device.

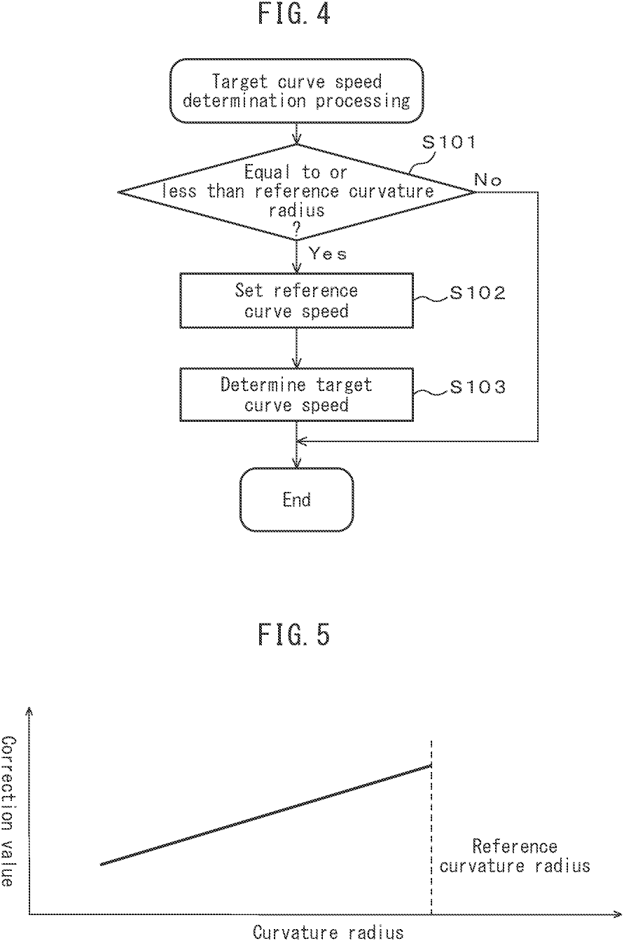

FIG. 4 is an example of an operation flow chart for target curve speed determination processing by a drive planning device 15 of the embodiment. Target curve speed determination processing by the drive planning device 15 will be described with reference to FIG. 4. The drive planning device 15 carries out target curve speed determination processing according to the operation flow chart shown in FIG. 4, at a target curve speed assessment time having a predetermined cycle. The cycle at which the target curve speed determination processing is carried out is preferably no longer than the driving plan creation time.

First, the setting unit 232 refers to map information to determine whether or not the curvature radius of the road in the zone for which the next driving plan is to be created is equal to or less than a reference curvature radius (step S101). The setting unit 232 is an example of a reference curve speed setting unit. The setting unit 232 refers to map information to acquire the curvature radius of the road of the zone for which the next driving plan is to be created, for the road on which the vehicle 10 is traveling. The setting unit 232 may also calculate the zone for which the next driving plan is to be created based on the current location of the vehicle 10 and the most recent average speed of the vehicle 10. The setting unit 232 also determines the reference curvature radius based on the speed of the vehicle 10. For example, the setting unit 232 may refer to a table in which the relationship between speed and reference curvature radius is registered, stored in the memory 22, and may determine the reference curvature radius based on the speed of the vehicle 10. When the zone for which the next driving plan is to be created includes a road having a curvature radius that is equal to or less than the reference curvature radius, the setting unit 232 determines that the curvature radius of the road is equal to or less than the reference curvature radius (step S101 - Yes). When the zone for which the next driving plan is to be created does not include a road having a curvature radius that is equal to or less than the reference curvature radius, on the other hand, it determines that the curvature radius of the road is not equal to or less than the reference curvature radius (step S101 - No).

When it has been determined that the curvature radius of the road is equal to or less than the reference curvature radius (step S101 - Yes), the setting unit 232 sets the reference curve speed to be the speed reference for traveling of the vehicle 10 on a curved road (step S102). The reference curve speed is a speed representing the upper limit for the vehicle 10 traveling on a road having a curvature radius that is equal to or less than the reference curvature radius. The setting unit 232 calculates the reference curve speed based on the curvature radius of the road, the reference acceleration allowed as lateral acceleration, and the mass of the vehicle 10. The reference acceleration preferably represents the upper limit for the size of lateral acceleration that does not cause discomfort for an ordinary adult driver. The reference acceleration may also be determined according to the driver-set speed. The mass of the vehicle 10 may be its mass when the vehicle 10 is carrying a typical number of passengers and a typical amount of luggage. As shown in FIG. 1B, the reference curve speed decreases with a lower curvature radius.

The determining unit 233 then determines a target curve speed as the target speed to which the vehicle 10 is to be controlled when the vehicle 10 is traveling on a curved road, based on the reference curve speed and the current correction value corresponding to the curvature radius of the road (step S103), thus completing the series of processing steps. The determining unit 233 is an example of a target curve speed determining unit. The planning unit 231 uses the target curve speed to create a driving plan for traveling on the curved road. Calculation processing of the correction value will be described below.

When it has been determined that the curvature radius of the road is not equal to or less than the reference curvature radius (step S101 - No), the series of processing steps is complete. The planning unit 231 uses the driver-set speed to create the driving plan.

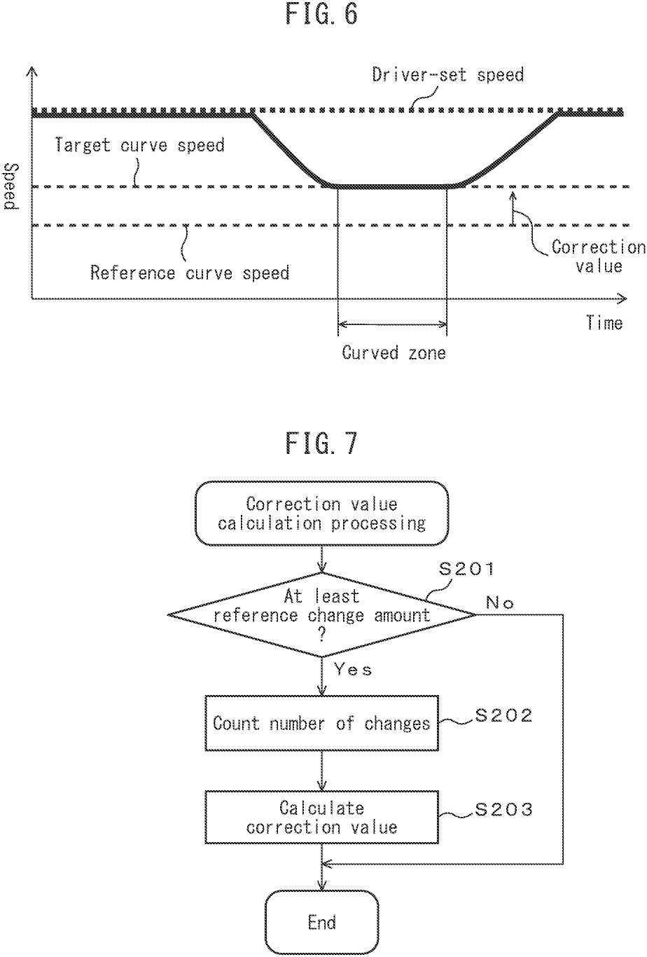

Processing by which the determining unit 233 determines the target curve speed in step S103 will now be described with reference to FIG. 5 and FIG. 6.

The determining unit 233 determines a target curve speed Va as the target speed to which the vehicle 10 is to be controlled when the vehicle 10 is traveling on a curved road, based on the reference curve speed and the current correction value corresponding to the curvature radius of the road. Specifically, the determining unit 233 calculates the target curve speed Va to be the sum of the reference curve speed Vb and the current correction value M corresponding to the curvature radius of the road, according to the following formula (1).

$$\text{Va} = \text{Vb} + \text{M}$$

FIG. 5 is a diagram showing an example of the relationship between correction value and reference curvature radius. For this embodiment, the correction value is calculated according to the curvature radius of the road. For example, the calculating unit 235 may calculate the correction value for each demarcation, where a demarcation is every 10 m of curvature radius. The correction value for the curvature radius is the same within a single demarcation. The initial value for the correction value may be zero. In this case, the target curve speed matches the reference curve speed. For the example shown in FIG. 5, the correction value is a positive value, but the correction value may also be a negative value. An upper limit is preferably set for the absolute value of the correction value. The upper limit of the correction value is determined by design and experimentation, for example. The upper limit for the correction value may also be determined according to the curvature radius of the road.

FIG. 6 is a diagram illustrating target curve speed determination processing. The setting unit 232 also determines the reference curvature radius based on the driver-set speed, which is the speed of the vehicle 10. Since the curvature radius of the road in the zone for which the next driving plan is to be created is equal to or less than the reference curvature radius, the setting unit 232 sets the reference curve speed to be the speed reference for traveling of the vehicle 10 on a curved road. The setting unit 232 also calculates the target curve speed to be the sum of the reference curve speed and the current correction value corresponding to the curvature radius of the road. Since the target curve speed is slower than the driver-set speed in the example shown in FIG. 6, the planning unit 231 generates a driving plan so as to decelerate to the target curve speed until entering the zone where the curvature radius of the road is equal to or less than the reference curvature radius (curved road zone), and after having passed through the curved road zone, to accelerate to the driver-set speed.

Correction value calculation processing will now be explained with reference to FIG. 7. FIG. 7 is an example of an operation flow chart for correction value calculation processing by a drive planning device 15 of the embodiment. The drive planning device 15 carries out correction value calculation processing according to the operation flow chart shown in FIG. 7 each time the vehicle 10 passes through a curved zone with a target curve speed determined by the target curve speed determination processing.

The counting unit 234 first determines whether or not the absolute value of the amount of change in the speed of the vehicle 10 that has changed from the target curve speed by driver operation is at least a reference change amount, when the vehicle 10 has passed through a curved zone (step S201).

FIG. 2A shows an example where the speed of the vehicle 10 has changed from the target curve speed by accelerating operation by the driver when the vehicle 10 is in a curved road zone. In the curved road zone, the amount of change in speed S, such that the difference between the actual speed of the vehicle 10 and the target curve speed deviates by at least a predetermined reference speed difference, is calculated by formula (2) below. In the formula, t1 represents the time at which the speed of the vehicle 10 begins to diverge from the speed of the driving plan by at least a reference divergence. The variable t2 represents the time at which the vehicle 10 reaches the end point of the curved road zone when the speed of the vehicle 10 has diverged from the speed of the driving plan by at least the reference divergence, and v_{acc} represents the difference between the speed of the vehicle 10 and the target curve speed.

$$\text{S} = {\int }_{t 1}^{t 2} {v}_{a c c} d t$$

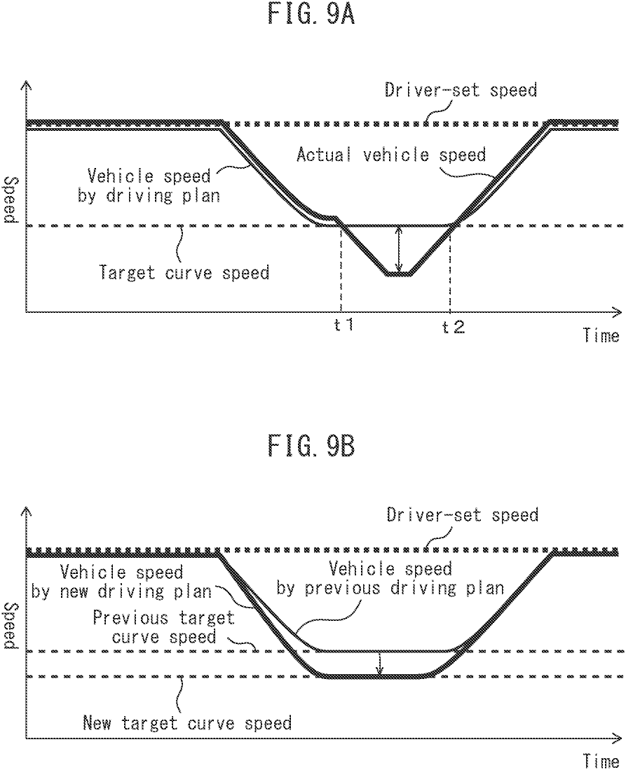

When the speed of the vehicle 10 has changed from the target curve speed due to an accelerating operation by the driver, the amount of change in speed S is positive. When the speed of the vehicle 10 has changed from the target curve speed due to a decelerating operation by the driver, on the other hand (see FIG. 9A), the amount of change in speed S is negative.

The reference change amount may be established in consideration of variation in the speed of the vehicle 10 while it travels at a constant speed. The reference divergence may likewise be established in consideration of variation in the speed of the vehicle 10 while it travels at a constant speed.

If the amount of change in the speed of the vehicle 10 is at least a reference change amount (step S201 - Yes), the counting unit 234 increments by one the number of times that the speed of the vehicle 10 has been changed from the target curve speed by driver operation (step S202). The initial value for the number of changes may be zero.

Each time the number of changes has been counted, the calculating unit 235 calculates a new correction value for the reference curve speed corresponding to the curvature radius of the road based on the correction coefficient determined based on the number of changes, and the amount of change in the speed of the vehicle 10 that has changed from the target curve speed by driver operation (step S203), thus completing the series of processing steps. The calculating unit 235 is an example of the correction value calculating unit.

When the amount of change in the speed of the vehicle 10 is not at least the reference change amount (step S201 - No), the series of processing steps is complete.

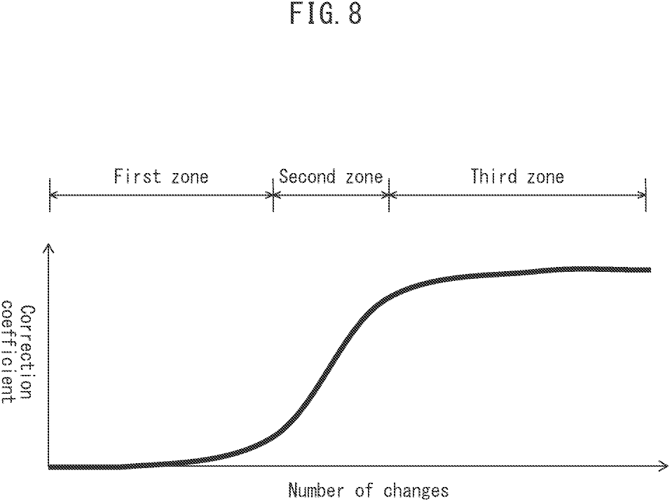

Processing in which the calculating unit 235 calculates a new correction value will now be explained with reference to FIG. 8. FIG. 8 is a diagram showing an example of the relationship between the correction coefficient and number of changes. The relationship between the correction coefficient and number of changes has a first zone in which the correction coefficient increases as the number of changes increases, a second zone in which the correction coefficient increases more than the first zone as the number of changes increases, and a third zone in which the correction coefficient increases less than the second zone as the number of changes increases. It is possible that accelerating or decelerating operation by the driver may be coincidental at the early stage during the course of learning the correction values, and therefore the correction coefficient is low (first zone). When it has been determined that there is a tendency for the driver to perform acceleration or deceleration operation, the correction coefficient is high (second zone). There is essentially an upper limit to the correction coefficient, however (third zone). The correction coefficient used may be a sigmoid function, for example. For this embodiment, the correction coefficient is positive.

The calculating unit 235 calculates the new correction value to be the sum of the products of the correction coefficients and amounts of change in vehicle speed for each time the speed of the vehicle 10 has been changed from the target curve speed by driver operation.

Each product Lᵢ of the correction coefficient and amount of change in vehicle speed each time the speed of the vehicle 10 has been changed from the target curve speed by driver operation is calculated by the following formula (3). The variable “i” is the change number, “αᵢ” is the correction coefficient for the “i”th change, and Sᵢ is the amount of change in speed for the “i”th change. The initial value α₀ of the correction coefficient may be zero.

$${L}_{i} = {a}_{i} {S}_{i}$$

When the driver has performed an accelerating operation, the amount of change in speed Sᵢ is positive and the correction coefficient αᵢ is zero or a positive value, and therefore the product Lᵢ is zero or positive. When the driver has performed a decelerating operation, on the other hand, the amount of change in speed Sᵢ is negative and the correction coefficient αᵢ is zero or a positive value, and therefore the product Lᵢ is zero or negative.

The new correction value M is calculated by the following formula (4). Here, “m” is the current number of changes.

$$\text{M} = {\sum }_{i = 0}^{m} {L}_{i}$$

An example of operation of the drive planning device 15, in which the speed of the vehicle 10 has been changed from the target curve speed due to accelerating operation by the driver when the vehicle 10 is in a curved road zone, will now be explained with reference to FIG. 2A and FIG. 2B.

As shown in FIG. 2A, when the vehicle 10 travels on a curved road having a curvature radius that is equal to or less than the reference curvature radius, the drive planning device 15 determines the target curve speed to be a target speed at which the vehicle 10 is to be controlled when the vehicle 10 is traveling on the curved road, based on the reference curve speed and the current correction value corresponding to the curvature radius of the road.

The drive planning device 15 determines a new correction value for the target curve speed corresponding to the curvature radius of the road, when a driver who feels that the speed of the vehicle 10 is slow has performed an accelerating operation so that the speed of the vehicle 10 has been increased above the target curve speed when the vehicle 10 is traveling on a curved road.

The vehicle 10 in a curved road zone may sometimes travel based on multiple driving plans. In this case, the new correction value is determined based on the amount of change in speed across multiple driving zones in the curved road zone, between time t1, at which divergence of speed has begun, and time t2.

As shown in FIG. 2B, when the vehicle 10 travels on a subsequent curved road having the same curvature radius as the current one, the drive planning device 15 determines a new target curve speed based on the reference curve speed and the current correction value corresponding to the curvature radius of the road. The new target curve speed is corrected so as to reflect the previous accelerating operation by the driver and to be increased above the previous target curve speed.

In the driving plan that includes the new target curve speed, the speed at which the vehicle 10 travels on the curved road is faster than the previous target curve speed, and therefore the timing at which the speed of the vehicle 10 begins to decrease from the driver-set speed may be slower than before in some cases.

An example of operation of the drive planning device 15, wherein the speed of the vehicle 10 has been changed from the target curve speed due to decelerating operation by the driver when the vehicle 10 is in a curved road zone, will now be explained with reference to FIG. 9A and FIG. 9B.

FIG. 9A is a diagram illustrating correction value calculation processing when the vehicle 10 has decelerated, and FIG. 9B is a diagram illustrating a new target curve speed.

As shown in FIG. 9A, when the vehicle 10 travels on a curved road having a curvature radius that is equal to or less than the reference curvature radius, the drive planning device 15 determines the target curve speed to be a target speed at which the vehicle 10 is to be controlled when the vehicle 10 is traveling on the curved road, based on the reference curve speed and the current correction value corresponding to the curvature radius of the road.

The correction value when the vehicle 10 has decelerated is calculated in the same manner as described above for when the vehicle 10 has accelerated. In the example shown in FIG. 9A, tl represents the time at which the speed of the vehicle 10 begins to diverge from the speed of the driving plan by at least a reference divergence. The variable t2 is the time at which the speed of the vehicle 10 has stopped diverging by at least the reference divergence from the speed of the driving plan, or the time at which the vehicle 10 has reached the end point of the curved road zone while the speed of the vehicle 10 is diverged from the speed of the driving plan by at least the reference divergence.

The drive planning device 15 determines a new correction value for the target curve speed corresponding to the curvature radius of the road, when a driver who feels that the speed of the vehicle 10 is fast has performed a decelerating operation so that the speed of the vehicle 10 has been decreased below the target curve speed when the vehicle 10 is traveling on a curved road,. As mentioned above, the new correction value is determined based on the amount of change in speed between time t1 at which divergence of speed has begun, and time t2 at which divergence of speed has stopped.

As shown in FIG. 9B, when the vehicle 10 travels on a subsequent curved road having the same curvature radius as the current one, the drive planning device 15 determines a new target curve speed based on the reference curve speed and the current correction value corresponding to the curvature radius of the road. The new target curve speed is corrected so as to reflect the previous decelerating operation by the driver and to be decreased below the previous target curve speed.

In the driving plan that includes the new target curve speed, the speed at which the vehicle 10 travels on the curved road is slower than the previous target curve speed, and therefore the timing at which the speed of the vehicle 10 begins to decrease from the driver-set speed may be earlier than before in some cases.

As explained above, each time the number of changes has been counted, the drive planning device of this embodiment determines the target curve speed using a correction value calculated based on the correction coefficient determined based on the number of changes, and the amount of change in the speed of the vehicle that has changed from the target curve speed by driver operation. This allows the drive planning device to cause the vehicle to travel on the curved road at a lateral acceleration that is satisfactory for different drivers.

Modification Example 1 and Modification Example 2 of the drive planning device of this embodiment will now be described.

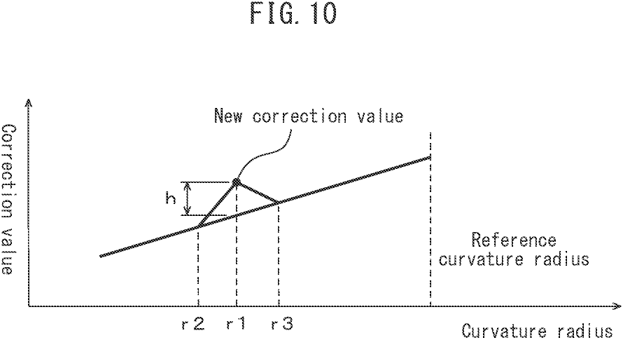

FIG. 10 is a diagram illustrating the relationship between correction value and reference curvature radius, for Modification Example 1. For this modification example, when the new correction value has been determined, the calculating unit 235 corrects the current correction value for the curvature radius of the road before and after so that the difference h between new correction value and the current correction value for the curvature radius of the road before and after the curvature radius of the road for which the new correction value was calculated, is at or below a predetermined reference value.

As shown in FIG. 10, the new correction value is calculated with respect to the curvature radius r1. The difference between the current correction value for the curvature radius of the road before and after the curvature radius r1, and the new correction value, is larger than the predetermined reference value. The new correction value is in a discontinuous relationship with the current correction value for the curvature radius of the road before and after the curvature radius r1.

The calculating unit 235 therefore connects the correction value at locations r2, r3 with predetermined curvature radii differing before and after the curvature radius r1 with the new correction value for the curvature radius r1 by a straight line (or curved line), and uses the correction value represented by the straight line (or curved line) as the current correction value for the curvature radius of the road before and after the curvature radius r1. Since the new correction value is thus in a continuous relationship with the correction value for the curvature radius of the road for the road before and after the curvature radius r1, the target curve speed while the vehicle 10 is traveling on a curved road with a different curvature radius is set to the continuous value.

In the example shown in FIG. 10, the difference h between the current correction value for the curvature radius and the new correction value is positive, but the aforementioned explanation also applies when the difference h is a negative value.

Modification Example 2 of the drive planning device 15 of the embodiment will now be described. In this modification example, the calculating unit 235 calculates a new correction value for the reference curve speed corresponding to the curvature radius of the road, for each type of road. When the new correction value has been determined for one road on which the vehicle 10 is traveling, the calculating unit 235 calculates a new correction value for the reference curve speed corresponding to the curvature radius of another road, based on the new correction value.

The type of road, may be, for example, the main lane of a high-speed road, a junction road connecting together two different high-speed roads, or an interchange road connecting a high-speed road with a general road. Such roads can potentially have curved zones.

The calculating unit 235 may also calculate the correction value for a road with few changes by multiplying the correction value for a road with many changes by a predetermined coefficient. This can yield an appropriate new correction value for different types of roads that are curved roads with the same curvature radius.

For example, when calculating a correction value Mi for an interchange road based on a correction value Mj for a junction road, the formula Mi = Mj × β may be used. The value of β used here may be β = 0.7, for example.

When calculating a correction value Mh for a main road based on a correction value Mj for a junction road, the formula Mh = Mj × β may be used. The value of β used here may be β = 0.8, for example.

When calculating a correction value Mj for a junction road based on a correction value Mi for an interchange road, the formula Mj = Mi × β may be used. The value of β used here may be β = 0.5, for example.

When calculating a correction value Mh for a main road based on a correction value Mi for an interchange road, the formula Mh = Mi × β may be used. The value of β used here may be β = 0.4, for example.

When calculating a correction value Mj for a junction road based on a correction value Mh for a main road, the formula Mj = Mh × β may be used. The value of β used here may be β = 0, for example.

When calculating a correction value Mi for an interchange road based on a correction value Mh for a main road, the formula Mi = Mh × β may be used. The value of β used here may be β = 0, for example.

The vehicle control device, the computer program for vehicle control and the method for controlling a vehicle according to the embodiment described above may incorporate appropriate modifications that are still within the gist of the disclosure. Moreover, the technical scope of the disclosure is not limited to these embodiments, and includes the invention and its equivalents as laid out in the Claims.

For example, when the location where the vehicle is located is in bad weather with rain or snow, the correction coefficient may be zero or smaller, compared to when it is in a favorable weather location with sunny weather, for example. Since the road surface is wetted in bad weather, the vehicle driving conditions will differ from a weather situation with a dry road surface. This can lower the effect that correction in bad weather may have over the correction value in good weather. The correction value may also be determined separately for good weather and for bad weather.

1. A vehicle control device comprising:
a processor configured to
set a reference curve speed as a speed reference when a vehicle is traveling on a curved road, based on a speed of the vehicle and a curvature radius of the road on which the vehicle is traveling,
determine a target curve speed as a target speed at which the vehicle is to be controlled based on the reference curve speed and a current correction value corresponding to the curvature radius of the road when the vehicle is traveling on the curved road,
count a number of changes as the number of times the speed of the vehicle has been changed from the target curve speed by driver operation when the vehicle is traveling on the curved road, and
calculate a new correction value for the reference curve speed corresponding to the curvature radius of the road based on a correction coefficient determined based on the number of changes, and the amount of change in the speed of the vehicle that has changed from the target curve speed by the driver operation each time the number of changes has been counted,
wherein the subsequent target curve speed is determined based on the reference curve speed and the new correction value corresponding to the curvature radius of the road.

2. The vehicle control device according to claim 1, wherein the processor is further configured to calculate the new correction value as the sum of the products of the correction coefficients and the amounts of change in the speed of the vehicle for each time the speed of the vehicle has been changed from the target curve speed by the driver operation.

3. The vehicle control device according to claim 1, wherein relationship between the correction coefficient and number of changes has a first zone in which the correction coefficient increases as the number of changes increases, a second zone in which the correction coefficient increases more than the first zone as the number of changes increases, and a third zone in which the correction coefficient increases less than the second zone as the number of changes increases.

4. The vehicle control device according to claim 1, wherein the processor is further configured to correct the current correction value for the curvature radius of the road before and after the curvature radius of the road for which the new correction value was calculated so that difference between the new correction value and the current correction value for the curvature radius of the road before and after is at or below a predetermined reference value when the new correction value has been determined.

5. The vehicle control device according to claim 1, wherein the processor is further configured to
calculate the new correction value for the reference curve speed corresponding to the curvature radius of the road for each type of road, and
calculate the new correction value for the reference curve speed corresponding to the curvature radius of another road, based on the new correction value when the new correction value has been determined for one road on which the vehicle is traveling.

6. A computer-readable, non-transitory storage medium storing a computer program for vehicle control, which causes a processor execute a process, the process comprising:
setting a reference curve speed as a speed reference when a vehicle is traveling on a curved road, based on a speed of the vehicle and the curvature radius of the road on which the vehicle is traveling;
determining a target curve speed as a target speed at which the vehicle is to be controlled based on the reference curve speed and a current correction value corresponding to the curvature radius of the road when the vehicle is traveling on the curved road;
counting a number of changes as the number of times the speed of the vehicle has been changed from the target curve speed by driver operation when the vehicle is traveling on the curved road; and
calculating a new correction value for the reference curve speed corresponding to the curvature radius of the road based on a correction coefficient determined based on the number of changes, and the amount of change in the speed of the vehicle that has changed from the target curve speed by the driver operation each time the number of changes has been counted,
wherein the subsequent target curve speed is determined based on the reference curve speed and the new correction value corresponding to the curvature radius of the road.

7. A method for controlling a vehicle which is carried out by a vehicle control device and the method comprising:
setting a reference curve speed as a speed reference when a vehicle is traveling on a curved road, based on a speed of the vehicle and the curvature radius of the road on which the vehicle is traveling;
determining a target curve speed as a target speed at which the vehicle is to be controlled based on the reference curve speed and a current correction value corresponding to the curvature radius of the road when the vehicle is traveling on the curved road;
counting a number of changes as the number of times the speed of the vehicle has been changed from the target curve speed by driver operation when the vehicle is traveling on the curved road; and
calculating a new correction value for the reference curve speed corresponding to the curvature radius of the road based on a correction coefficient determined based on the number of changes, and the amount of change in the speed of the vehicle that has changed from the target curve speed by the driver operation each time the number of changes has been counted,
wherein the subsequent target curve speed is determined based on the reference curve speed and the new correction value corresponding to the curvature radius of the road.
